(19) United States
(12) Patent Application Publication
(10) Pub. No.: US 2008/0104158 A1
(43) Pub. Date: May 1, 2008

(54) Implementation of adaptive filters of reduced complexity

(76) Inventors: Arash Farhoodfar, Irvine, CA (US); Scott R. Powell, Carlsbad, CA (US); Peiqing Wang, Irvine, CA (US)

Correspondence Address: MCANDREWS HELD & MALLOY, LTD, 500 WEST MADISON STREET, SUITE 3400, CHICAGO, IL, 60661, US

(21) Appl. No.: 11/586,111

(22) Filed: Oct. 25, 2006

(51) Int. Cl. G06F 17/14

(52) U.S. Cl. 708/405

(57) ABSTRACT

Herein described is at least a method for implementing an adaptive digital filter of reduced implementation complexity. The method comprises computing at least one complex discrete Fourier transform of a complex data sequence using approximately one-half the number of points used in computing said discrete Fourier transform of a real valued sequence. Further, herein described is an adaptive digital filter of reduced implementation complexity. The adaptive digital filter comprises at least one circuitry for computing a complex discrete Fourier transform of a complex data sequence using approximately one-half the number of points used in computing the discrete Fourier transform of a real valued sequence. The adaptive digital filter may be employed in a 10 Gbit/sec Ethernet transceiver.

### BACKGROUND OF THE INVENTION

Implementation of linear adaptive filters may require a huge VLSI complexity or gate count. For example, implementing a discrete Fourier transform (DFT) or an inverse discrete Fourier transform (IDFT) in an adaptive filter requires a significant amount of circuitry. As a consequence, the implementation complexity increases with each additional DFT or IDFT operation employed in an adaptive filter. This often results in substantial power consumption and fabrication costs.

Furthermore, typical frequency domain block LMS (least mean square) adaptive filtering introduces quantization errors resulting from noise. Such noise may occur from imaginary components when real valued sequences are converted into the frequency domain. As a consequence, the filter coefficients of a typical adaptive filter may not be very accurate and the LMS algorithm used to perform the adaptive filtering may suffer.

The limitations and disadvantages of conventional and traditional approaches will become apparent to one of skill in the art, through comparison of such systems with some aspects of the present invention as set forth in the reminder of the present application with reference to the drawings.

### BRIEF SUMMARY OF THE INVENTION

Various aspects of the invention provide a method for implementing an adaptive frequency domain filter of reduced implementation complexity. The various aspects are substantially shown in and/or described in connection with at least one of the following figures, as set forth more completely in the claims.

These and other advantages, aspects, and novel features of the present invention, as well as details of illustrated embodiments, thereof, will be more fully understood from the following description and drawings.

### BRIEF DESCRIPTION OF THE DRAWINGS

FIG. 1 is a block diagram of a Block LMS adaptive filter that utilizes a method and system to reduce the number of discrete Fourier transform (DFT) computations and inverse discrete Fourier transform (IDFT) computations in accordance with an embodiment of the invention.

FIG. 2A is an operational flow diagram illustrating a method of obtaining a 2M-point real discrete Fourier transform (DFT) by way of performing an M-point complex discrete Fourier transform (DFT) in accordance with an embodiment of the invention.

FIG. 2B is an operational flow diagram illustrating a method of obtaining a 2M-point real inverse discrete Fourier transform (IDFT) by way of performing an M-point complex inverse discrete Fourier transform (IDFT) in accordance with an embodiment of the invention.

FIG. 3 is block diagram of a representative embodiment of a transceiver that utilizes one or more adaptive digital filters for transmitting and receiving data at 10 Gbit/sec over Ethernet, for example, in accordance with an embodiment of the invention.

### DETAILED DESCRIPTION OF THE INVENTION

Various aspects of the invention can be found in a method and a system of performing adaptive frequency domain filtering. By using the various aspects of the invention, the number of computations required in implementing an adaptive digital filter may be reduced significantly. Because of a reduction in computation complexity, the adaptive digital filter may be implemented using reduced circuitry. Hence, an associated integrated circuit chip, such as a VLSI (very large scale integrated circuit) chip may be fabricated with less complexity and reduced silicon. The VLSI chip may be fabricated with a lower gate count, for example. The method and the system may comprise using one or more discrete Fourier transform (DFT) and inverse discrete Fourier transform (IDFT) computations within the adaptive digital filter. By way of employing the method and the system, a 2M-point real DFT/IDFT may be reduced to performing an “M-point” complex DFT/IDFT.

Advantages of utilizing the various aspects of the invention include the reduction of quantization errors that are typically introduced in a conventional adaptive digital filter. For example, real time coefficients of a typical adaptive digital filter may have imaginary noise components resulting from quantization errors occurring in the frequency domain. In comparison, the various aspects of the invention may eliminate such imaginary noise components. In a representative embodiment, the adaptive digital filter comprises a Block LMS (least mean square) adaptive filter (i.e., employs the Block LMS algorithm).

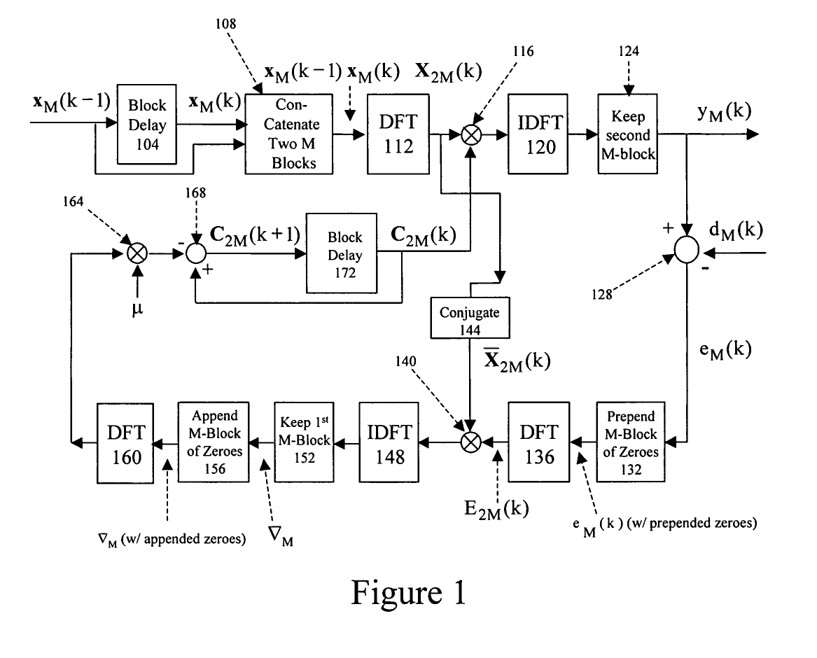

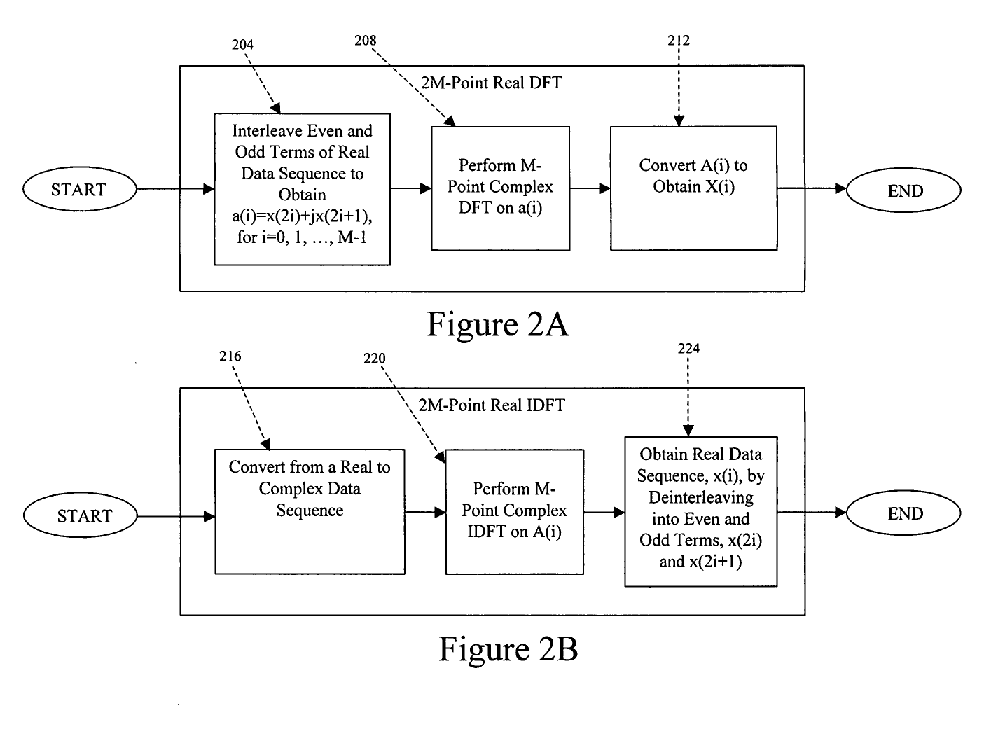

FIG. 1 is a block diagram of a Block LMS adaptive filter that utilizes a method and system to reduce the number of discrete Fourier transform (DFT) computations and inverse discrete Fourier transform (IDFT) computations in accordance with an embodiment of the invention. Compared to performing conventional 2M-point DFT and/or IDFT computations, the method and system may be used to perform “M-point” complex DFT and IDFT computations. The method and system may be applied to one or more DFT blocks 112, 136, 160 and IDFT blocks 120, 148 illustrated in FIG. 1. The Block LMS adaptive filter comprises an M-point block delay 104, a concatenator 108, a first discrete Fourier transform (DFT) block 112, a first multiplier 116, a first inverse discrete Fourier transform (IDFT) block 120, a first parser 124, a first subtracter 128, a prepender 132, a second DFT block 136, a second multiplier 140, a complex conjugate block 144, a second IDFT block 148, a second parser 152, an appender 156, a third DFT block 160, a third multiplier 164, a second subtracter 168, and a 2M-point block delay 172. A time domain signal, x_{M}(k-1), is input into the M-point block delay 104. The M-point block delay 104 delays x_{M}(k-1) to generate a time domain signal x_{M}(k). Thereafter, the two data sequences or blocks, x_{M}(k-1) and x_{M}(k), are concatenated by the concatenator 108. The concatenated signal, x_{M}(k-1)x_{M}(k) is transmitted to the DFT block 112 where an M-point complex discrete Fourier transform is performed. The DFT block 112 comprises one or more circuitries capable of performing an M-point complex DFT. The method employed in performing the M-point complex DFT will be more fully described in connection with FIG. 2A. The output of the DFT block 112 is transmitted to the first multiplier 116 where it is multiplied by one or more filter coefficient estimates, C_{2M}(k). The product from the first multiplier 116 is subsequently input into the IDFT block 120 where an M-point complex IDFT is performed. The output of the IDFT block 120 is then transmitted to the first parser 124 where the second of the two concatenated blocks is kept. The output of the first parser 124, y_{M}(k) may also be considered the output of the Block LMS adaptive filter. An error signal e_{M}(k) is generated by subtracting d_{M}(k) from y_{M}(k) using the first subtracter 128. The error signal e_{M}(k) is transmitted to the prepender 132 wherein it is prepended by an M-point block of zeroes. After prepending is completed, the prepended signal is transmitted to the second DFT block 136 where an M-point complex discrete Fourier transform is performed. The output of the second DFT block 136, E_{2M}(k), is transmitted into the second multiplier 140 where it is multiplied by the output from the complex conjugate block 144. The complex conjugate block 144 operates on the output of the first DFT block 112 to generate a complex conjugate output. The output of the second multiplier 140 is transmitted to the second IDFT block 148 where an M-point complex inverse discrete Fourier transform is performed. The second parser 152 generates a signal, ∇_{M}, by keeping the first M-points (or first M-samples) of the 2M-point block. The second parser 152 transmits the first M-points to the appender 1 56 such that M zeroes may be appended to the end of the first M-points received. The resulting 2M-point block is then transmitted to the third DFT block 160 where an M-point complex DFT is performed. The output of the third DFT block 160 is transmitted to the third multiplier 164 where it is multiplied by μ. The output of the third multiplier 164 is subsequently transmitted to the second subtracter 168 where it is subtracted from the data sequence, C_{2M}(k). The output of the second subtracter 168 undergoes a 2M-point block delay through the 2M-point block delay 172. The output of the 2M-point block delay 172, C_{2M}(k), is then fed back to the first multiplier 116. As described, the one or more DFT blocks 112, 136, 160 and IDFT blocks 120, 148 utilize an M-point complex DFT/IDFT as opposed to a conventional 2M-point real DFT/IDFT. As a consequence, the implementation complexity of the Block LMS adaptive filter is significantly reduced.

FIG. 2A is an operational flow diagram illustrating a method of obtaining a 2M-point real discrete Fourier transform (DFT) by way of performing an M-point complex discrete Fourier transform (DFT) in accordance with an embodiment of the invention. The process of obtaining the 2M-point real DFT comprises performing an M-point complex DFT. The process generates the 2M-point real DFT of x(i) (i.e., X(i)=DFT[x(i)]). The process starts at step 204, where even and odd terms of a real time domain data sequence, x(i), are interleaved to obtain a complex data sequence, a(i), where a(i)=x(2i)+jx(2i+1), for i=0, 1, . . . , M-1. In order to obtain a(i), the interleaving process may involve a number of operations. For example, the process may include pairing consecutive samples of the real time domain data sequence to generate a sequence of paired samples. Then, multiplying the odd term of each pair of the sequence of paired samples by the imaginary unit, j. Thereafter, the even and odd terms are summed in each pair of the complex sequence of paired samples to generate a complex valued sequence, a(i). Each of these operations may be implemented using one or more circuitries or hardware. Thereafter, at step 208, an M-point complex discrete Fourier transform is performed on a(i), to yield A(i). Step 208 may be implemented using any type of circuitry. Next, at step 212, X(i) is obtained from A(i) by solving the equation: X(i)=0.5(A(i)+A*(M−i))−0.5jw_{2M}ⁱ(A(i)−A*(M−i)), for i=0,1, . . . ,M where A(i) corresponds to said discrete Fourier transform of the complex valued input sequence, a(i), w_{2M} corresponds to a Twiddle factor associated with the discrete Fourier transform of the real valued input sequence, x(i), and A* corresponds to the complex conjugate of the discrete Fourier transform of the complex valued input sequence, A(i). Step 212 may be implemented using any type of circuitry. The one or more circuitries previously described may be fabricated on an integrated circuit chip, for example.

FIG. 2B is an operational flow diagram illustrating a method of obtaining a 2M-point real inverse discrete Fourier transform (IDFT) by way of performing an M-point complex inverse discrete Fourier transform (IDFT) in accordance with an embodiment of the invention. The process of obtaining the 2M-point real IDFT comprises performing an M-point complex IDFT. The process generates the 2M-point real IDFT of X(i) (i.e., x(i)=IDFT[X(i)]). The process starts at step 216, where X(i) is converted from a real data sequence to a complex data sequence, A(i). This is accomplished by solving for A(i) using the equation: A(i)=0.5(X(i)+X*(M−i))+0.5jw_{2M}⁻ⁱ(X(i)−X*(M−i)), for i=0,1, . . . , M. In the previous equation, w_{2M} corresponds to a Twiddle factor associated with the discrete Fourier transform of the real valued input sequence, x(i), while X* corresponds to the complex conjugate of X(i). Next, at step 220, an M-point complex IDFT is performed on A(i), to yield a(i). Thereafter, at step 224, x(i) is obtained from a(i) by solving the equations:

x(2i)=0.5(a(i)+a*(i))

x(2i+1)=−0.5j(a(i)−a*(i)),

for i=0,1, . . . , M−1, where a*(i) corresponds to the complex conjugate of the complex valued input sequence, a(i). Each of the preceding steps of FIG. 2B may be implemented using one or more circuitries. The one or more circuitries may be fabricated on an integrated circuit chip, for example.

The methods described in connection with FIGS. 2A and 2B incorporate the complex conjugate symmetry property of real valued time domain signals. The signals x_{M} and ∇_{M} are real valued time domain signals. As a consequence, the following equations hold for a data signal in the frequency domain:

X_{2M}(i)=X*_{2M}(2M−i)

E_{2M}(i)=E*_{2M}(2M−i)

C_{2M}(i)=C*_{2M}(2M−i)

Because of this complex conjugate symmetry property, computation of one or more DFTs and IDFTs in the Block LMS adaptive filter amounts to addressing only M+1 frequency components. For example, as was shown in connection with FIG. 2A, only 0 to M points (or samples) are needed in the computation of the complex “M-point” DFT. In addition to reducing the number of computations, the complex conjugate symmetric property of these equations insures that imaginary values are not generated as a result of quantization noise in the Block LMS adaptive filter. Otherwise, these equations would be violated. For example, use of the methods described in FIGS. 2A and 2B obviate the accumulation of quantization errors resulting from imaginary noise while estimating the filter coefficient, C_{2M}(k), in the Block LMS adaptive filter described in connection with FIG. 1.

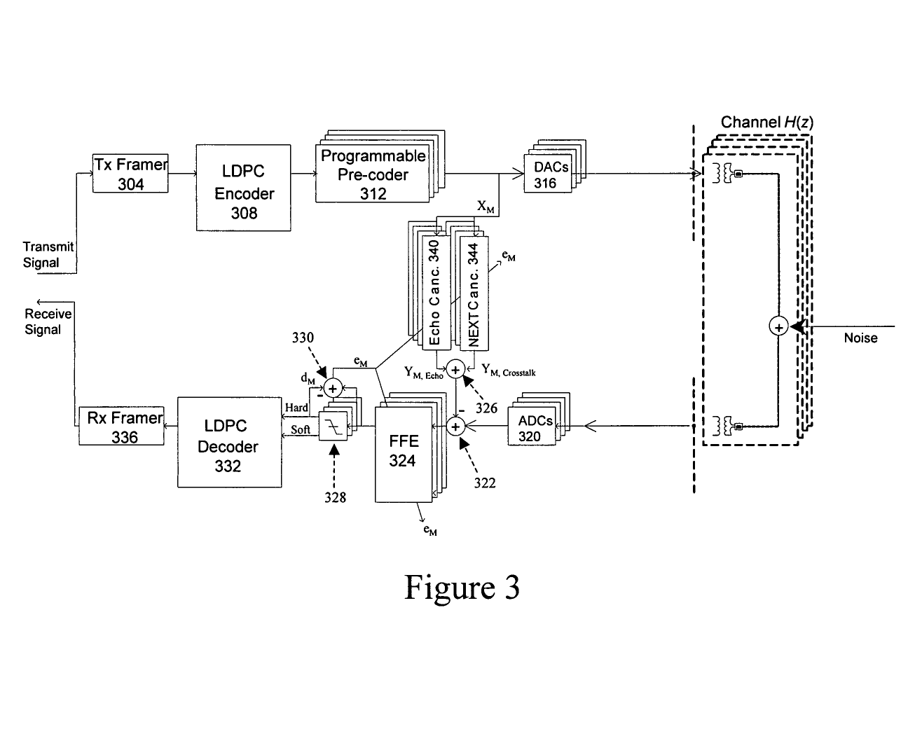

FIG. 3 is block diagram of a representative embodiment of a transceiver that utilizes one or more adaptive digital filters for transmitting and receiving data at 10 Gbit/sec over Ethernet, for example, in accordance with an embodiment of the invention. The representative embodiment shown in FIG. 3 may conform to 10 GBASE-T standards. In a representative embodiment, each of the one or more adaptive digital filters used to implement the transceiver comprises the Block LMS adaptive filter described in connection with FIG. 1. Further, each of the one or more adaptive digital filters may incorporate the methods described in connection with FIGS. 2A and 2B, for implementing a discrete Fourier transform (DFT) or inverse discrete Fourier transform (IDFT). The transceiver may also be adapted for use in conformance with other standards. The transceiver is implemented in duplex configuration, where a first data signal is transmitted in the upper portion of the block diagram and a second data signal is received in the lower portion of the block diagram. The transceiver comprises a transmit (Tx) framer 304, a low density parity check (LDPC) encoder 308, one or more programmable precoders 312, one or more D/A converters (DACs) 316, and one or more A/D converters (ADCs) 320, a feed forward equalizer (FFE) module 324, a slicer module 328, a low density parity check (LDPC) decoder 332, a receive (Rx) deframer 336, one or more echo cancellers 340, and one or more near end crosstalk (NEXT) cancellers 344. The transceiver further comprises a first subtracter 322, an adder 326, and a second subtracter 330. The transceiver may be configured for transmitting and receiving data signals through one or more communication channels over a certain distance. In a representative embodiment, a communication channel may be characterized by a transfer function, H(z), as indicated in FIG. 3. The received signal may be affected by noise that is introduced into the communication channel. In a representative embodiment, the transceiver may transmit to a maximum of 100 meters. In a representative embodiment, the data is transmitted at 800 Mega symbols/second using 7 bits per symbol. Scrambling, or randomizing, of the transmit data may be necessary to minimize baseline wander and ensure proper operation of adaptive receiver subsystems such as clock recovery and equalization. The transmit framer 304 may be used to scramble the transmit data signal by way of an exemplary 58 bit self-synchronizing scrambler. Physical layer (i.e., PHY level) frames may contain data from 50 consecutive 65-bit XGMII (i.e., 10 Gbit media independent interface) data/control blocks. A CRC-8 (i.e., a type of cyclic redundancy check) may be computed across 50*65=3250 bits and appended to the frame. One additional bit may be added for vendor-specific purposes bringing the total PHY level frame payload to 1+50*65+8=3259 bits. The LDPC encoder 308 may apply a systematic code that adds 325 parity bits to blocks of 1723 data bits. Based on a frame payload of 3259 bits, 1723 bits may be encoded by the LDPC encoder 308 while 1536 bits may remain uncoded. In a representative embodiment, 325 parity bits are added to the 3259 bit frame payload to yield a total encoded frame size of 3584 bits. The one or more programmable precoders 312 may comprise Tomlinson-Harashima precorders (THPs), for example. The THPs may comprise IIR filters used to invert a channel response. Each of the THPs may use a non-linear element to avoid overflow and guarantee stability. Tomlinson-Harashima precoding may result in a uniformly distributed transmit signal with strictly limited peak amplitude. Coefficient values for the THP may be determined as part of a start-up sequence and may remain fixed during data transfer. In a representative embodiment, the transceiver transmits four channels at one quarter the required data rate (10 Gbits/second). For example, each channel may transmit at 2.5 Gbits/second to effectuate an overall transmission rate of 10 Gbits/second. In this case, each of the 4 outputs provided by 4 programmable precorders is transmitted to each of 4 echo cancellers 340 and 4 near end crosstalk cancellers 344, as indicated in FIG. 3. Each of the 4 echo cancellers 340 may comprise an adaptive digital filter (e.g., Block LMS adaptive filter). Likewise, each of the 4 near end crosstalk cancellers 344 may comprise an adaptive digital filter (e.g., Block LMS adaptive filter). The adaptive digital filter may comprise the Block LMS adaptive filter described in connection with FIG. 1 while the DFT and IDFT may be computed using the methods described in connection with FIGS. 2A and 2B. The input to each of the 4 echo cancellers 340 and 4 near end crosstalk cancellers 344 may correspond to the signal input, X_{M}, that was previously described in connection with FIG. 1. In a representative embodiment, each of the 4 echo cancellers 340 and 4 near end crosstalk cancellers 344 receives an error signal, e_{M}, as a control input. The output of each of the 4 echo cancellers 340 and 4 near end crosstalk cancellers 344 provides an estimate of the echo and near end crosstalk for each of the 4 transmitted channels. These estimates, Y_{M, Echo} and Y_{M, Crossttalk}, respectively, are provided as inputs to an adder 326. Corresponding echo and crosstalk may be combined or summed for each channel at the adder 326. The sum of each of the 4 channels, may be provided as an input to the first subtractor 322. Each of the 4 outputs from the one or more programmable precoders 312 is converted to an analog signal using one or more digital-to-analog converters (DACs) 316. The one or more DACs 316 may drive a 100 ohm twisted pair cable (through a transformer) using a differential signal. In a representative embodiment, the average transmit power of the transceiver is 5 dBm for 100 m (or greater) cables and this power may be attenuated as the cable length is reduced. When the 10 Gbit/second signal is received by the transceiver, the data signals transmitted by each of the 4 channels is converted into a digital representation by way of one or more analog-to-digital converters (ADCs) 320. These four digital signals are transmitted to the first subtracter 322 where they are subtracted by the corresponding channel outputs generated by the adder 326. The first subtracter 322 outputs 4 difference signals (corresponding to the 4 channels) into the feed forward equalizer (FFE) module 324. The FFE module 324 may comprise four FFE submodules, each of which correspond to one of four channels. Each of the four FFE submodules of the feed forward equalizer (FFE) module 324 receives the error signal, em, as a control input. The feed forward equalizer (FFE) module 324 functions to equalize the received signals by reversing the effects of the transfer function, H(z), that characterizes the communication channel. The feed forward equalizer (FFE) module 324 outputs the 4 equalized signals into a slicer module 328. The slicer module 328 may comprise four submodules, as shown in FIG. 3. The slicer module 328 processes each of the 4 equalized signals to generate hard decision outputs or estimates, d_{M}, for each of the 4 received data signals. Each of the submodules of the slicer module 328 may comprise any type of decision making circuitry, such as one or more comparators, for example. The second subtracter 330 is used to compute the difference between the received equalized signals and their corresponding estimates, d_{M}. The difference for each of the four channels (previously described as e_{M}) is transmitted as a control signal to each of the echo cancellers 340, to each of the near end crosstalk cancellers 344, and to each of the submodules of the FFE module 324. The control signals may be used to adjust or vary the estimate of echo and/or crosstalk generated by each of the 4 transmitted data signals. The LDPC decoder 332 may be used to select a code word (i.e., a data sequence of 512 symbols) that most closely matches a received data sequence. A soft decision output may be generated by the slicer module 328 for use by the LDPC decoder 332. The LDPC decoder 332 may decode this soft decision output to determine if the block matches an allowed LDPC codeword. Thereafter, all non-payload bits may be removed by a deframing operation performed by the receive deframer 336, prior to transmission to a MAC (media access control) layer.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

What is claimed is:

1. A method of reducing the number of computations when performing a discrete Fourier transform (DFT) of a real valued sequence having 2M samples, said DFT performed in an adaptive digital filter, said method comprising:
pairing consecutive samples of said real valued sequence to generate a sequence of paired samples, each pair of said sequence of paired samples comprising an even term and an odd term of said real valued sequence;
multiplying said odd term of each pair of said sequence of paired samples by the imaginary unit, j, to generate a complex sequence of paired samples, each paired sample of said complex sequence of paired samples comprising an even term and an odd imaginary term;
summing said even term and said odd imaginary term of each pair of said complex sequence of paired samples to generate a complex valued sequence, wherein each sample, a(i), of said complex valued sequence is represented by an equation a(i)=x(2i)+jx(2i+1), for i=0,1, . . . , M−1;
computing a discrete Fourier transform of said complex valued sequence, said discrete Fourier transform of said complex valued sequence performed over M+1 samples of said complex valued sequence; and
determining said discrete Fourier transform of said real valued sequence, X(i), by solving X(i)=0.5(A(i)+A*(M−i))−0.5jwⁱ(A(i)−A*(M−i)), for i=0,1, . . . , M, where A(i) corresponds to said discrete Fourier transform of said complex valued sequence, a(i), w corresponds to a Twiddle factor associated with said discrete Fourier transform of said real valued sequence, and A* corresponds to the complex conjugate of said discrete Fourier transform of said complex valued sequence.

2. The method of claim 1 wherein said adaptive digital filter comprises a block LMS adaptive digital filter.

3. The method of claim 2 wherein one or more time domain filter coefficients of said block LMS adaptive digital filter are real valued.

4. The method of claim 2 wherein one or more time domain filter coefficients of said block LMS adaptive digital filter comprise no imaginary noise components.

5. The method of claim 1 wherein use of said pairing, multiplying, summing, first computing, and second computing reduces quantization errors that result from typically performing said discrete Fourier transform of said real valued sequence.

6. An adaptive digital filter that employs a reduced number of computations for performing a discrete Fourier transform (DFT) of a real valued sequence, x(i) having 2M samples, comprising:
a first circuitry for pairing consecutive samples of said real valued sequence to generate a sequence of paired samples, each pair of said sequence of paired samples comprising an even term and an odd term of said real valued sequence;
a second circuitry for multiplying said odd term of each pair of said sequence of paired samples by an imaginary unit, j, to generate a complex sequence of paired samples, each paired sample of said complex sequence of paired samples comprising an even term and an odd imaginary term;
a third circuitry for summing said even term and said odd imaginary term of each pair of said complex sequence of paired samples to generate a complex valued sequence, wherein each sample, a(i), of said complex valued sequence is represented by an equation a(i)=x(2i)+jx(2i+1), for i=0,1, . . . , M−1; and
a fourth circuitry for computing a discrete Fourier transform of said complex valued sequence, said discrete Fourier transform of said complex valued sequence performed using M+1 samples of said complex valued sequence; and
a fifth circuitry for computing X(i), the DFT of x(i), by way of solving X(i)=0.5(A(i)+A*(M−i))−0.5jwⁱ(A(i)−A*(M−i)), for i=0,1, . . . , M, where A(i) corresponds to said discrete Fourier transform of said complex valued sequence, w corresponds to a Twiddle factor associated with said discrete Fourier transform of said real valued sequence, x(i), and A* corresponds to the complex conjugate of said discrete Fourier transform of said complex valued sequence.

7. The adaptive digital filter of claim 6 wherein said adaptive digital filter comprises a block LMS adaptive digital filter.

8. The adaptive digital filter of claim 7 wherein said first, second, third, fourth, and fifth circuitries are used in the computation of estimates of real valued time domain filter coefficients for said LMS adaptive digital filter.

9. The adaptive digital filter of claim 8 wherein said time domain filter coefficients comprise no imaginary noise components.

10. A method of reducing the number of computations when computing an inverse discrete Fourier transform (IDFT) of a first sequence having 2M samples, said IDFT performed in an adaptive digital filter, said method comprising:
computing a second sequence, A(i), by solving A(i)=0.5(X(i)+X*(M−i))+0.5jw⁻ⁱ(X(i)−X*(M−i)), for i=0,1, . . . ,M, where X(i) corresponds to said first sequence, w corresponds to a Twiddle factor associated with said first sequence, and X* corresponds to the complex conjugate of said first sequence;
computing an inverse discrete Fourier transform of said second sequence using M+1 samples to yield a third time domain sequence, a(i);
computing even terms of said third sequence, x(2i), by solving x(2i)=0.5(a(i)+a*(i)), for i=0,1, . . . ,M−1, where a*(i) corresponds to a complex conjugate of a(i); and
computing odd terms of said third sequence, x(2i+1), by solving x(2i+1)=−0.5j(a(i)−a*(i)), for i=0,1, . . . ,M−1, where a*(i) corresponds to a complex conjugate of a(i).

11. The method of claim 10 wherein said adaptive digital filter comprises a block LMS adaptive digital filter.

12. The method of claim 11 wherein one or more time domain filter coefficients of said LMS adaptive digital filter comprise no imaginary noise components.

13. An adaptive digital filter that employs a reduced number of computations for performing an inverse discrete Fourier transform (IDFT) of a first sequence, X(i), having 2M samples, comprising:
a first circuitry for computing a second sequence, A(i), by solving A(i)=0.5(X(i)+X*(M−i))+0.5jw⁻ⁱ(X(i)−X*(M−i)), for i=0,1, . . . ,M, w corresponds to a Twiddle factor associated with said first sequence, and X* corresponds to the complex conjugate of said first sequence;
a second circuitry for computing an inverse discrete Fourier transform of said second sequence using M+1 samples to yield a third time domain sequence, a(i);
a third circuitry for computing even terms of said third sequence, x(2i), by solving x(2i)=0.5(a(i)+a*(i)), for i=0,1, . . . ,M−1, where a*(i) corresponds to a complex conjugate of a(i); and
a fourth circuitry for computing odd terms of said third sequence, x(2i+1), by solving x(2i+1)=−0.5j(a(i)−a*(i)), for i=0,1, . . . ,M−1, where a*(i) corresponds to a complex conjugate of a(i).

14. The adaptive digital filter of claim 13 wherein said adaptive digital filter comprises a block LMS adaptive digital filter.

15. The adaptive digital filter of claim 13 wherein said first, second, third, and fourth circuitries are used in the process of computing real valued time domain filter coefficients for said LMS adaptive digital filter.

16. The adaptive digital filter of claim 13 wherein said time domain filter coefficients comprise no imaginary noise components.

17. A method of reducing implementation complexity of an adaptive digital filter comprising:
computing at least one complex discrete Fourier transform of a complex data sequence using approximately one-half the number of points used in computing said discrete Fourier transform of a first real valued sequence; and
computing at least one complex inverse discrete Fourier transform of a complex data sequence using approximately one-half the number of points used in computing said inverse discrete Fourier transform of a second real valued sequence.

18. The method of claim 17 wherein said adaptive digital filter comprises a Block LMS adaptive filter.

19. An adaptive digital filter of reduced implementation complexity comprising:
at least one circuitry for computing a complex discrete Fourier transform of a complex data sequence using approximately one-half the number of points used in computing said discrete Fourier transform of a first real valued sequence; and
at least one circuitry for computing a complex inverse discrete Fourier transform of a complex data sequence using approximately one-half the number of points used in computing said inverse discrete Fourier transform of a second real valued sequence.

20. The adaptive digital filter of claim 19 wherein said adaptive digital filter comprises a Block LMS adaptive filter.

21. The adaptive digital filter of claim 19 wherein said adaptive digital filter is used to implement an echo canceller in a transceiver.

22. The adaptive digital filter of claim 21 wherein said transceiver transmits and receives according to 10GBASE-T standards.

23. The adaptive digital filter of claim 19 wherein said adaptive digital filter is used to implement a near end crosstalk canceller in a transceiver.

24. The adaptive digital filter of claim 22 wherein said transceiver transmits and receives according to 10GBASE-T standards.
